(19) United States
(12) Patent Application Publication
(10) Pub. No.: US 2026/0331041 A1
(43) Pub. Date: Oct. 22, 2026

(54) DISPLAY CONTROL CIRCUIT AND DISPLAY COMPENSATION METHOD

(71) Applicant: Novatek Microelectronics Corp., Hsinchu (TW)

(72) Inventors: Chang Ta Hsieh, New Taipei City (TW); Tsu Cheng Li, Taichung City (TW); Yen-Tao Liao, Hsinchu City (TW); Hui-Feng Lin, Taichung City (TW)

(73) Assignee: Novatek Microelectronics Corp., Hsinchu (TW)

(21) Appl. No.: 19/186,605

(22) Filed: Apr. 22, 2025

(51) Int. Cl. G09G 3/3208

(52) U.S. Cl. CPC G09G 3/3208; G09G 2300/0842; G09G 2320/0271; G09G 2320/0285

(57) ABSTRACT

A display control circuit and a display compensation method are provided. The display control circuit includes a storage unit and a compensation unit. The storage unit is configured to store a plurality of lookup tables corresponding to different predetermined emission duty cycles of a display panel. The compensation unit is configured to select at least one lookup table from the plurality of lookup tables according to an emission duty cycle corresponding to a current input frame. The compensation unit is configured to search each selected lookup table according to a first pixel data in a previous input frame and a second pixel data in the current input frame to obtain at least one output grayscale value for the each selected lookup table. The compensation unit is configured to determine a compensated second pixel data according to the at least one obtained output grayscale value.

### BACKGROUND

### Technical Field

The disclosure relates a circuit; particularly, the disclosure relates to a display control circuit and a display compensation method.

### Description of Related Art

In the driving process of a traditional organic light-emitting diode (OLED) display panel, when the OLED display panel switches screens (for example, from a previous frame to a next frame), due to the operating characteristics of the OLED display control circuit, the display brightness of the next frame may be insufficient, resulting in dynamic image blur and afterimages on the display screen.

### SUMMARY

The display control circuit of the disclosure includes a storage unit and a compensation unit. The storage unit is configured to store a plurality of lookup tables corresponding to different predetermined emission duty cycles of a display panel. The compensation unit is coupled to the storage unit. The compensation unit is configured to select at least one lookup table from the plurality of lookup tables according to an emission duty cycle corresponding to a current input frame. The compensation unit is configured to search each selected lookup table according to a first pixel data in a previous input frame and a second pixel data in the current input frame to obtain at least one output grayscale value for the each selected lookup table. The compensation unit is configured to determine a compensated second pixel data according to the at least one obtained output grayscale value.

The display compensation method of the disclosure includes the following steps: selecting at least one lookup table from the plurality of lookup tables according to an emission duty cycle corresponding to a current input frame; searching each selected lookup table according to a first pixel data in a previous input frame and a second pixel data in the current input frame to obtain at least one output grayscale value for the each selected lookup table; and determining a compensated second pixel data according to the at least one obtained output grayscale value.

Based on the above, according to the display control circuit and the display compensation method of the disclosure, the display control circuit may effectively compensate the grayscale value of the pixel data for each frame.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit schematic diagram of a display control circuit according to an embodiment of the disclosure.

FIG. 2 is a flowchart of a display compensation method according to an embodiment of the disclosure.

FIG. 3 is a schematic diagram of a display compensation operation according to an embodiment of the disclosure.

FIG. 4 is a schematic diagram of a two-dimensional lookup table according to an embodiment of the disclosure.

FIG. 5 is a schematic diagram of a relationship between a plurality of predetermined emission duty cycles and corresponding compensated pixel data according to an embodiment of the disclosure.

### DESCRIPTION OF THE EMBODIMENTS

Reference is now made in detail to exemplary embodiments of the disclosure, and examples of the exemplary embodiments are illustrated in the accompanying drawings. Wherever possible, the same reference numerals are used in the drawings and descriptions to refer to the same or similar parts.

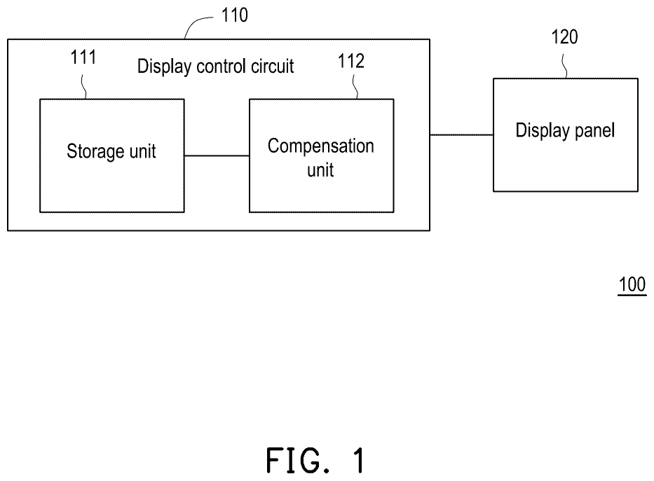

FIG. 1 is a circuit schematic diagram of a display device according to an embodiment of the disclosure. Referring to FIG. 1, the display device 100 includes a display control circuit 110 and a display panel 120. The display control circuit 110 is coupled to the display panel 120. The display control circuit 110 includes a storage unit 111 and a compensation unit 112. The storage unit 111 is coupled to the compensation unit 112. In the embodiment of the disclosure, the display control circuit 110 may be a timing controller, and there may be a display data driving circuit disposed between the display control circuit 110 and the display panel 120, which is omitted in FIG. 1. The display device 100 may be an organic light-emitting diode (OLED) display device, and the display panel 120 may be an OLED display panel. In one embodiment of the disclosure, the display control circuit 110 may also be integrated with a display driver integrated into a single chip.

In the embodiment of the disclosure, the storage unit 111 may be a memory circuit, and the memory circuit may be, for example, aa static random access memory (SRAM), a flash memory, a video random access memory (V RAM) or a buffer memory. The storage unit 111 is configured to store data of a plurality of lookup tables corresponding to different predetermined emission duty cycles of the display panel 120. Each of the plurality of lookup tables is configured to record a plurality of first grayscale values, a plurality of second grayscale values, and a plurality of output grayscale values. Each of the plurality of output grayscale values is determined by one of the plurality of first grayscale values and one of the plurality of second grayscale values. In the embodiment of the disclosure, the display control circuit 110 may receive input display data, and obtain compensation data for each frame and each pixel (or each sub-pixel) by search the at least one lookup table according to the input display data. The display control circuit 110 may perform grayscale value compensation (i.e. the brightness compensation) on the input display data according to the compensation data for each frame and each pixel, so as to effectively drive the display panel 120.

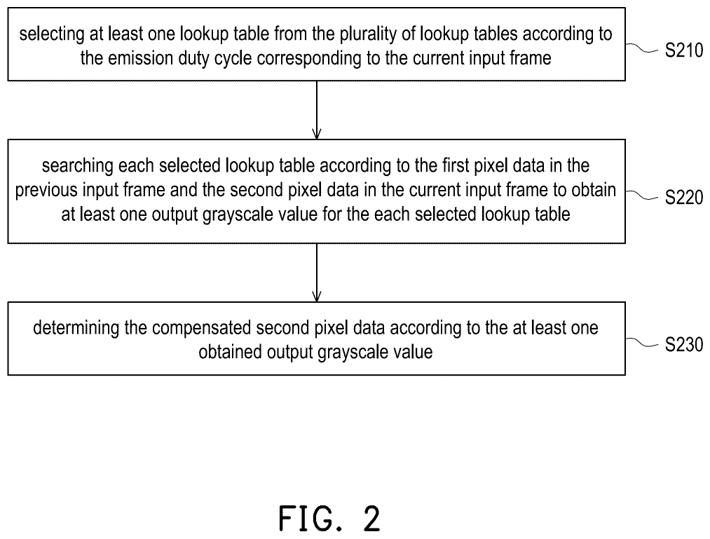

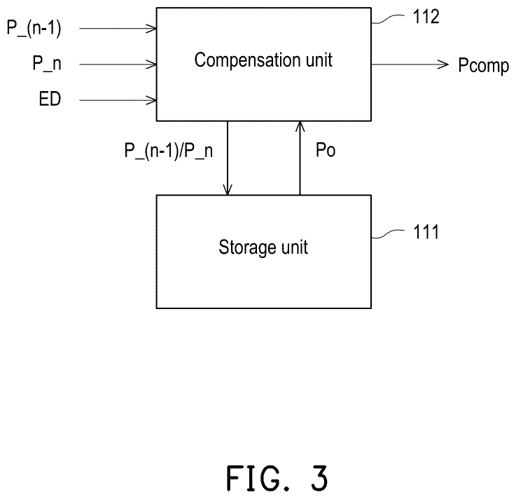

FIG. 2 is a flowchart of a display compensation method according to an embodiment of the disclosure. FIG. 3 is a schematic diagram of a display compensation operation according to an embodiment of the disclosure. Referring to FIG. 1 to FIG. 3, the display control circuit 110 may execute the following steps S210 to S230. In the embodiment of the disclosure, the compensation unit 112 may receive a first pixel data P_(n-1) in a previous input frame, a second pixel data P_n in the current input frame, and an emission duty cycle ED corresponding to the current input frame from a display data source. The first pixel data P_(n-1) and the second pixel data P_n may be subpixel data of same color, such as a red sub-pixel data, a sub-green pixel data, or a sub-blue pixel data. In step S210, the compensation unit 112 may select at least one lookup table from the plurality of lookup tables according to the emission duty cycle ED corresponding to the current input frame from the storage unit 111. In step S220, the compensation unit 112 may search each selected lookup table according to the first pixel data P_(n-1) in the previous input frame and the second pixel data P_n in the current input frame to obtain at least one output grayscale value Po for the each selected lookup table. In step S230, the display control circuit 110 may determine a compensated second pixel data Pcomp according to the at least one obtained output grayscale value Po.

In the embodiment of the disclosure, the storage unit 111 may store the plurality of lookup tables corresponding to different predetermined emission duty cycles. In one of embodiments of the disclosure, the each of the plurality of lookup tables may be a two-dimensional lookup table respectively. The each of the plurality of lookup tables may record a plurality of first grayscale values, a plurality of second grayscale values and a plurality of output grayscale values, and each of the plurality of output grayscale values is determined by one of the plurality of first grayscale values and one of the plurality of second grayscale values. Therefore, regarding to a selected one of the first lookup table and the second lookup table, the compensation unit 112 may search a first grayscale value same as the first pixel data P_(n-1) or two first grayscale values which are the most closet to the first pixel data P_(n-1) and a second grayscale value same as the second pixel data P_n or two second grayscale values which are the most closet to the second pixel data P n from the each selected lookup table, to obtain at least one output grayscale value Po of the each pixel for the each selected lookup table.

In one another embodiment of the disclosure, the each of the plurality of lookup tables may be a one-dimensional table respectively. The each of the plurality of lookup tables may record a plurality of grayscale difference values and a plurality of output grayscale values, and each of the plurality of output grayscale values is determined by one of the plurality of grayscale difference values. The compensation unit 112 may subtract first pixel data P_(n-1) in the previous input frame from the second pixel data P_n in the current input frame to obtain the grayscale difference value with respect to the each pixel. The compensation unit 112 may search a grayscale difference value same as the calculated data difference or two grayscale difference values which are the most closet to the calculated data difference from the each selected one of the first lookup table and the second lookup table according to the calculated grayscale difference value with respect to the each pixel, to obtain the at least one output grayscale value Po for the each selected lookup table.

In addition, in the embodiment of the disclosure, the at least one output grayscale value Po may be directly used as the compensated second pixel data Pcomp, but the disclosure is not limited thereto. In one embodiment of the disclosure, the at least one output grayscale value Po may be added to the second pixel data to generate the compensated second pixel data Pcomp.

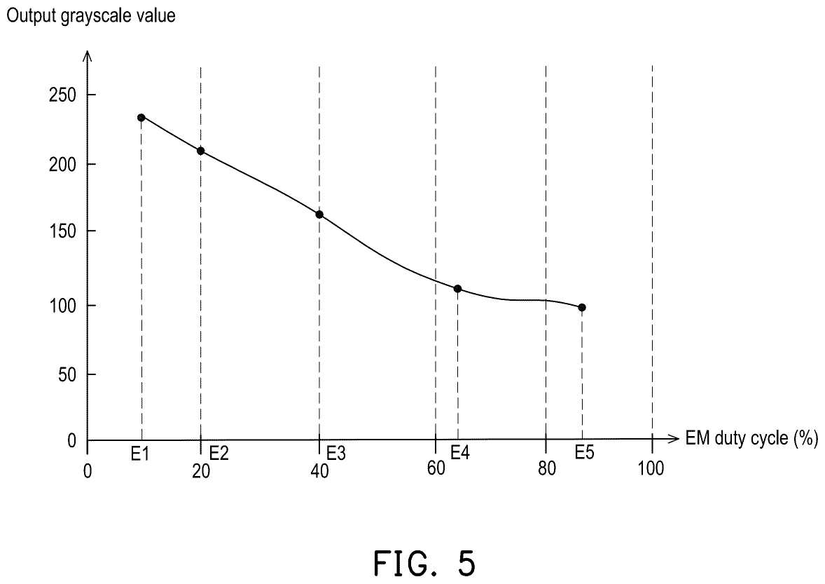

More specifically, in the embodiment of the disclosure, the compensation unit 112 may select one lookup table to be searched in response to that the emission duty cycle ED corresponding to the current input frame being the same as one of the plurality of predetermined emission duty cycles corresponding to the plurality of lookup tables. The storage unit 111 may store the different plurality of lookup tables respectively corresponding to the different predetermined emission duty cycles, such as the predetermined emission duty cycles E1-E5 shown in FIG. 5, which may be 10%, 20%, 40%, 65% and 90% respectively.

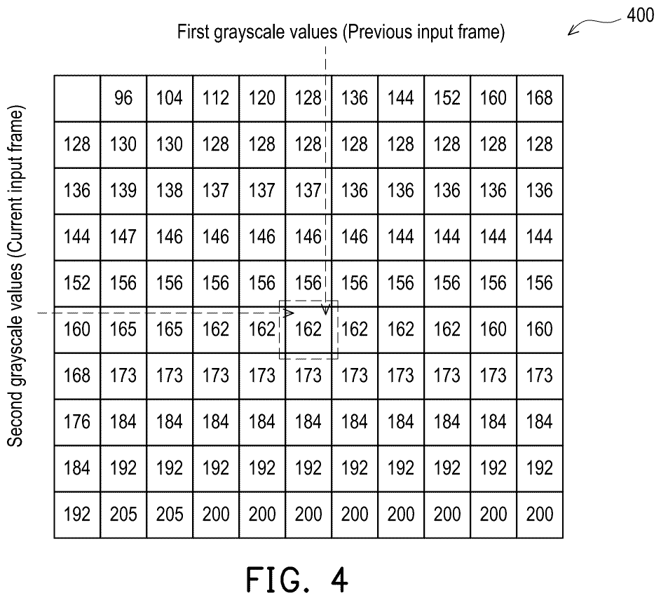

For example, when the emission duty cycle ED corresponding to the current input frame is 40%, the compensation unit 112 may select the one lookup table corresponding to the predetermined emission duty cycle of 40%. And then, taking one sub-pixel as an example, referring to FIG. 4, FIG. 4 is a schematic diagram of a two-dimensional lookup table according to an embodiment of the disclosure. Take FIG. 4 as a lookup table corresponding to a predetermined emission duty E3 (40%) shown in FIG. 5. As shown in FIG. 4, the selected lookup table 400 may be used for one color sub-pixel (e.g., the red sub-pixel, the green sub-pixel, or the blue sub-pixel) and correspond to the predetermined emission duty cycle of 40%. The selected lookup table 400 may record a plurality of first grayscale values (i.e. 96 to 168, the step size may be 8), a plurality of second grayscale values (i.e. 128 to 192, the step size may be 8) and a plurality of output grayscale values, and an output grayscale vales is determined by one of the plurality of first grayscale values (i.e. 96 to 168) and one of the plurality of second grayscale values (i.e. 128 to 192). In an exemplary condition, the first pixel data P_(n-1) is 128 and the second pixel data P_n is 160, and the compensation unit 112 may search a first grayscale value 128, same as the first pixel data, and search a second grayscale value 160, same as the second pixel data, from the selected lookup table 400. The compensation unit 112 may accordingly obtain an output grayscale value 162 from of the selected lookup table 400.

In another exemplary condition, the first pixel data P_(n-1) is 124 and the second pixel data P_n is 156, and the compensation unit 112 searches two first grayscale values 120 and 128, which are the most closet to the first pixel data P_(n-1) (124), and searches two second grayscale values 152 and 160, which are the most closet to the second pixel data P_n (156) from the selected lookup table 400. The compensation unit 112 may accordingly obtain two output grayscale values (e.g., 156 and 162) of the selected lookup table 500. The compensation unit 112 may perform interpolation calculation on the two obtained output grayscale values (e.g., 156 and 162) to generate one output grayscale value (e.g., 159) for determining the compensated second pixel data Pcomp.

FIG. 5 is a schematic diagram of a relationship between a plurality of predetermined emission duty cycles and corresponding compensated pixel data according to an embodiment of the disclosure. The storage unit 111 may store the different plurality of lookup tables respectively corresponding to the different predetermined emission duty cycles, where the predetermined emission duty cycles E1-E5 may be 10%, 20%, 40%, 65% and 90% respectively, and the predetermined emission duty cycles E1-E5 are corresponding to individual lookup tables for determining the compensated second pixel data. When the emission duty cycle ED corresponding to the current input frame is 40% equivalent to E3, the compensation unit 112 may select the one lookup table (e.g., the lookup table 400) corresponding to the predetermined emission duty cycle E3 to obtain the one output grayscale value (e.g., 162).

In one embodiment of the disclosure, the compensation unit 112 may select a first lookup table and a second lookup table from the plurality of lookup tables in response to that the emission duty cycle ED corresponding to the current input frame is between a first predetermined emission duty cycle corresponding to the first lookup table and a second predetermined emission duty cycle corresponding to the second lookup table.

For example, when the emission duty cycle ED corresponding to the current input frame is 30%, the compensation unit 112 may select the first lookup table corresponding to the predetermined emission duty cycle E2 (20%) and the second lookup table corresponding to the predetermined emission duty cycle E3 (40%). For each of the second of the first lookup table and the second lookup table, the compensation unit 112 performs the steps S210 to S230 of FIG. 2 to obtain two compensated second pixel data corresponding to the predetermined emission duty cycles E2 and E3.

In the regard, each of the first lookup table and the second lookup table may record a plurality of first grayscale values, a plurality of second grayscale values and a plurality of output grayscale values, and each output grayscale vales is determined by one of the plurality of first grayscale values and one of the plurality of second grayscale values. The compensation unit 112 may search a first grayscale value same as the first pixel data or two first grayscale values which are the most closet to the first pixel data and a second grayscale value same as the second pixel data or two second grayscale values which are the most closet to the second pixel data from each of the first lookup table and the second lookup table, and the compensation unit 112 may accordingly obtain at least one of the plurality of output grayscale values of the searched lookup tables.

Specifically, when the compensation unit 112 searches the two first grayscale values which are the most closet to the first pixel data and the two second grayscale values which are the most closet to the second pixel data from each of the first lookup table and the second lookup table. The compensation unit 112 may accordingly obtain a plurality of output grayscale values of the searched lookup tables. The compensation unit 112 may perform interpolation calculation on the plurality of obtained output grayscale values with respect to each of the first lookup table and the second lookup table to respectively generate a first final output grayscale value and a second final output grayscale value. The compensation unit 112 may perform another interpolation calculation on the first final output grayscale value and the second final output grayscale value to generate an interpolation result taken as the compensated second pixel data according to a first predetermined emission duty cycle corresponding to the first lookup table and a second predetermined emission duty cycle corresponding to the second lookup table.

In another case, when the compensation unit 112 searches the first grayscale value same as the first pixel data and the second grayscale value same as the second pixel data, the compensation unit 112 may accordingly obtain one output grayscale value of the searched lookup tables. The compensation unit 112 may perform interpolation calculation on the first grayscale value and the second grayscale value with respect to each of the first lookup table and the second lookup table to generate a final output grayscale value as the compensated second pixel data.

Referring to FIG. 5 again, when the emission duty cycle ED corresponding to the current input frame is 30% which is between E2 and E3, the compensation unit 112 may generate a final compensated second pixel data (e.g., 190) according to a first compensated second pixel data (e.g., 210) which is generated according to the first lookup table corresponding to the predetermined emission duty cycle E2 and a second compensated second pixel data (e.g., 170) which is generated according to the second lookup table corresponding to the predetermined emission duty cycle E3.

In one embodiment of the disclosure, the each of the first lookup table and the second lookup table may record a plurality of grayscale difference values and a plurality of output grayscale values corresponding to the plurality of grayscale difference values. The compensation unit 112 may calculate a data difference between the second pixel data and the first pixel data. The compensation unit may search a grayscale difference value same as the data difference or two grayscale difference values which are the most closet to the data difference from each of the first lookup table and the second lookup table. The compensation unit 112 may accordingly obtain the at least one output grayscale value from the plurality of output grayscale values of the searched lookup tables.

In another embodiment of the disclosure, the storage unit 111 may store two lookup tables, and the compensation unit 112 may select one lookup table to be searched according to a result of comparing the emission duty cycle ED corresponding to the current input frame and a threshold emission duty cycle. For example, when the emission duty cycle ED is higher than the threshold emission duty cycle, the compensation unit 112 may select one of the two lookup tables to obtain the at least one output grayscale value which is used for generating the compensated second pixel data. When the emission duty cycle ED is equal to or lower than the threshold emission duty cycle, the compensation unit 112 may select another one of the two lookup tables to obtain the at least one output grayscale value which is used for generating the compensated second pixel data.

In summary, the display control circuit and the display compensation method of the disclosure may compensate the grayscale value of each pixel and each frame by according to the each current pixel data and each previously pixel data, so as to quickly improve the pixel with insufficient brightness in the OLED display panel in the each frame.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A display control circuit, comprising:
a storage unit, configured to store a plurality of lookup tables corresponding to different reference emission duty cycles of a display panel; and
a compensation unit, coupled to the storage unit, and configured to select at least one lookup table from the plurality of lookup tables according to an emission duty cycle corresponding to a current input frame,
wherein the compensation unit is configured to search each selected lookup table according to a first pixel data in a previous input frame and a second pixel data in the current input frame to obtain at least one output grayscale value for the each selected lookup table,
wherein the compensation unit is configured to determine a compensated second pixel data according to the at least one obtained output grayscale value.

2. The display control circuit according to claim 1, wherein each of the plurality of lookup tables records a plurality of first grayscale values, a plurality of second grayscale values and a plurality of output grayscale values, and each of the plurality of output grayscale values is determined by one of the plurality of first grayscale values and one of the plurality of second grayscale values.

3. The display control circuit according to claim 1, wherein each of the plurality of lookup tables records a plurality of grayscale difference values and a plurality of output grayscale values, and each of the plurality of output grayscale values is determined by one of the plurality of grayscale difference values.

4. The display control circuit according to claim 1, wherein the compensation unit is configured to select one lookup table to be searched according to a result of comparing the emission duty cycle corresponding to the current input frame and a threshold emission duty cycle.

5. The display control circuit according to claim 1, wherein the compensation unit is configured to select one lookup table to be searched in response to that the emission duty cycle corresponding to the current input frame being the same as one of the plurality of predetermined emission duty cycles corresponding to the plurality of lookup tables.

6. The display control circuit according to claim 1, wherein the compensation unit is configured to select a first lookup table and a second lookup table from the plurality of lookup tables in response to that the emission duty cycle corresponding to the current input frame being between a first reference emission duty cycle corresponding to the first lookup table and a second reference emission duty cycle corresponding to the second lookup table.

7. The display control circuit according to claim 6, wherein each of the first lookup table and the second lookup table records a plurality of first grayscale values, a plurality of second grayscale values and a plurality of output grayscale values, and each output grayscale values is determined by one of the plurality of first grayscale values and one of the plurality of second grayscale values, and
wherein the compensation unit is configured to search a first grayscale value same as the first pixel data or two first grayscale values which are the most closet to the first pixel data and a second grayscale value same as the second pixel data or two second grayscale values which are the most closet to the second pixel data from each of the first lookup table and the second lookup table, and the compensation unit is configured to accordingly obtain at least one of the plurality of output grayscale values of the searched lookup tables.

8. The display control circuit according to claim 7, wherein the compensation unit is configured to perform interpolation calculation on a plurality of obtained output grayscale values with respect to each of the first lookup table and the second lookup table to respectively generate a first final output grayscale value and a second final output grayscale value, and the compensation unit is configured to perform another interpolation calculation on the first final output grayscale value and the second final output grayscale value to generate an interpolation result taken as the compensated second pixel data according to a first predetermined emission duty cycle corresponding to the first lookup table and a second predetermined emission duty cycle corresponding to the second lookup table.

9. The display control circuit according to claim 6, wherein each of the first lookup table and the second lookup table records a plurality of grayscale difference values and a plurality of output grayscale values corresponding to the plurality of grayscale difference values,
wherein the compensation unit is configured to calculate a data difference between the second pixel data and the first pixel data, the compensation unit is configured to search a grayscale difference value same as the data difference or two grayscale difference values which are the most closet to the data difference from each of the first lookup table and the second lookup table, and the compensation unit is configured to accordingly obtain the at least one output grayscale value from the plurality of output grayscale values of the searched lookup tables.

10. A display compensation method, comprising:
selecting at least one lookup table from the plurality of lookup tables according to an emission duty cycle corresponding to a current input frame;
searching each selected lookup table according to a first pixel data in a previous input frame and a second pixel data in the current input frame to obtain at least one output grayscale value for the each selected lookup table; and
determining a compensated second pixel data according to the at least one obtained output grayscale value.

11. The display compensation method according to claim 10, wherein each of the plurality of lookup tables records a plurality of first grayscale values, a plurality of second grayscale values and a plurality of output grayscale values, and each of the plurality of output grayscale values is determined by one of the plurality of first grayscale values and one of the plurality of second grayscale values.

12. The display compensation method according to claim 10, wherein each of the plurality of lookup tables records a plurality of grayscale difference values and a plurality of output grayscale values, and each of the plurality of output grayscale values is determined by one of the plurality of grayscale difference values.

13. The display compensation method according to claim 10, wherein the step of searching the each selected lookup table comprising:
selecting one lookup table to be searched according to a result of comparing the emission duty cycle corresponding to the current input frame and a threshold emission duty cycle.

14. The display compensation method according to claim 10, wherein the step of searching the each selected lookup table comprising:
selecting one lookup table to be searched in response to that the emission duty cycle corresponding to the current input frame being the same as one of plurality of the predetermined emission duty cycles corresponding to the plurality of lookup tables.

15. The display compensation method according to claim 10, wherein the step of obtaining the at least one output grayscale value comprises:
selecting a first lookup table and a second lookup table from the plurality of lookup tables in response to that the emission duty cycle corresponding to the current input frame being between a first predetermined emission duty cycle corresponding to the first lookup table and a second predetermined emission duty cycle corresponding to the second lookup table.

16. The display compensation method according to claim 15, wherein each of the first lookup table and the second lookup table records a plurality of first grayscale values, a plurality of second grayscale values and a plurality of output grayscale values, and each output grayscale values is determined by one of the plurality of first grayscale values and one of the plurality of second grayscale values,
wherein the step of obtaining the at least one output grayscale value further comprises:
searching a first grayscale value same as the first pixel data or two first grayscale values which are the most closet to the first pixel data and a second grayscale value same as the second pixel data or two second grayscale values which are the most closet to the second pixel data from each of the first lookup table and the second lookup table; and
obtaining at least one of the plurality of output grayscale values of the searched lookup tables.

17. The display compensation method according to claim 16, wherein the step of determining the compensated second pixel data comprises:
performing interpolation calculation on a plurality of obtained output grayscale values with respect to each of the first lookup table and the second lookup table to respectively generate a first final output grayscale value and a second final output grayscale value; and
performing another interpolation calculation on the first final output grayscale value and the second final output grayscale value to generate an interpolation result taken as the compensated second pixel data according to a first predetermined emission duty cycle corresponding to the first lookup table and a second predetermined emission duty cycle corresponding to the second lookup table.

18. The display compensation method according to claim 15, wherein each of the first lookup table and the second lookup table records a plurality of grayscale difference values and a plurality of output grayscale values corresponding to the plurality of grayscale difference values,
wherein the step of obtaining the at least one output grayscale value further comprises:
calculating a data difference between the second pixel data and the first pixel data;
searching a grayscale difference value same as the data difference or two grayscale difference values which are the most closet to the data difference from each of the first lookup table and the second lookup table; and
obtaining the at least one output grayscale value from the plurality of output grayscale values of the searched lookup tables.
